(19) United States
(12) Patent Application Publication
(10) Pub. No.: US 2017/0297404 A1
(43) Pub. Date: Oct. 19, 2017

(54) Removable spindle assembly for torsion axles

(71) Applicant: Bernhardt P. Goettker, Valley Center, CA (US)

(72) Inventor: Bernhardt P. Goettker, Valley Center, CA (US)

(21) Appl. No.: 14/999,253

(22) Filed: Apr. 14, 2016

(51) Int. Cl. B60G 21/05

(52) U.S. Cl. CPC B60G 21/051; B60G 2200/13

(57) ABSTRACT

A torsion axle arrangement is provided wherein the spindle is mounted to the suspension link by insertion into a split socket at one end of the suspension link, which is inclined with respect to the longitudinal axis of the suspension link. That connection is maintained by a bolt passing through the suspension link, engaging a mating groove in the spindle, and then clamping the ends of the split socket together. The bolt is anchored to the suspension link by a threaded connection external to the suspension link. A chamfer or surface recess is formed in the surface of the suspension link for immediate source identification.

### BACKGROUND OF THE INVENTION

Torsion axle arrangements are commonly used in vehicles of various types, including cargo trailers, recreational travel trailers, and boat trailers. These arrangements generally include an axle element (which is mounted transversely across a portion of the vehicle frame, usually from one side to the other), a suspension link element (which is mounted to the axle, usually at both ends thereof, and generally extends perpendicularly or radially outward from the axle length), and a spindle element (which is attached to the suspension link). The brakes and/or wheels of the vehicle are mounted on the spindle elements. The nature of the torsion axle is such that the suspension link allows the spindle and its associated wheels, etc., to move vertically with respect to the vehicle as the vehicle encounters various road conditions and/or the vehicle is subject to different loads. This occurs because a free end of the suspension link is movable, usually rotatably, with respect to the axle. As a result, the torsion axle arrangement can serve to absorb road stress forces which would otherwise be transferred directly to the vehicle and its contents.

To optimize performance and service life, brakes and wheels are typically mounted on the spindles so as to have a particular orientation when the vehicle is under its normal load. For example, particular radial orientations of brakes give better performance and useful life to those components. In certain hydraulic brakes, it has, for example, been found to be advisable to keep the bleeder opening at or near the top of the brake so that air does not become trapped in the hydraulic fluid. Similarly, with certain electrical brakes, it has, for example, been found to be advisable for the magnet to be at the bottom so that occasional bumps in the road do not accidentally actuate the brake. Also, spindles and/or components attached thereto typically include internal lubrication features. It has been found that ports for lubrication flow benefit from having a neutral axis so as to avoid stress concentrations. Connections between each element of a torsion axle arrangement often need to take into account the orientation, accessibility and connections to and of these other components.

In order to reduce manufacturing costs, it has been found advisable to use a common type of torsion axle arrangement for vehicles having several different expected loads. This is often accommodated at the factory by having the suspension link mounted or attached at various selected angles with respect to the normal or expected horizontal position of the axle element when the axle element is mounted on the vehicle. When the axle arrangement is later mounted to the vehicle and under normal load, the link is then rotated upward (or down, depending upon the application or use) by the forces (usually vehicle weight) applied to it, to rest at its normal “height,” giving sufficient wheel-to-vehicle clearance for normal use. Alternatively (or sometimes in addition), the same type of torsion axle arrangement is used to give various different axle heights or clearance above the road surface, again by varying the angle of the suspension link with respect to the normal horizontal orientation of the axle element. Connections between each element of a torsion axle arrangement often need to take into account these orientation objectives of the suspension link.

In addition, to accommodate both the desired radial orientation of the wheels and/or brakes, and/or of the lubrication features, and the selected angle which the suspension link is attached to the axle element, spindles can be attached to the suspension link in a variety of radial positions, ranging, for example, from 45 degrees down to 22 degrees up. These radial positions are selected such that during normal load and/or operation of the vehicle (when vehicle weight or load forces the suspension link to rotate about the horizontal axis of the axle element), the brake is upright and the lubrication openings are on a neutral axis, even though the brakes may be in an angled position and the lubrication openings at some other axis when the torsion axle arrangement is assembled at the factory.

Unfortunately, road stresses over an extended time, unusually high loads, “shock loads,” vehicle accidents, and the like can cause the spindle and/or related components to fail even though the suspension link and/or axle element remain in working order. In some prior arrangements, the spindle assembly often could not be effectively repaired in the field, since it was necessary as a practical matter to remove the entire torsion axle arrangement from the vehicle in order to make the needed repairs or replacement of components. In certain prior arrangements, the spindle was removably attached to the suspension link, such as by use of a tapered socket opening in the suspension link for mating with a tapered end of the spindle, and then a draw nut assembly was applied to that tapered end once so mated. However, that arrangement was not always field serviceable since sufficient access to the draw nut may be highly constrained in a given application or environment of use, and the draw nut is exposed to corrosion.

Further, when mounting the new spindle, some prior arrangements rely upon the field installer (sometimes an end user doing his own repair work) to provide the correct brake and lubrication port orientations. In certain field situations, and with a wide range of field installer skill, getting those orientations correct can be difficult and/or time consuming.

Another consideration is that vehicle manufacturers may not always purchase torsion axle arrangements from the same manufacturers, even within production of a given model of vehicle. Since torsion axle arrangements are typically mounted underneath a vehicle and/or are largely concealed during use, it is not always readily perceived by the end user and/or field installer which type or brand of torsion axle is needed for a given repair. Stampings or brand marks on the axle or its elements may be covered with grease, mud, debris, etc., or worn off due to the environment and nature of vehicle use. Spindles of each manufacturer may be similar in size and dimension, but not sufficiently identical to allow safe and reliable substitution. Thus, it can be important for a field installer to readily and accurately determine which brand and/or model of spindle is needed in a given instance.

Accordingly, it is an object of the present invention to provide an improved torsion axle arrangement. More specifically, the present invention is intended to provide torsion axle arrangements which:
a. are relatively inexpensive to manufacture and reliable in use,
b. facilitate reduced inventory costs to vehicle manufacturers and aftermarket parts suppliers for field installers,
c. are easy and relatively inexpensive to repair in the field,
d. resist corrosion effects,
e. provide reliable replication of factory settings in the field,
f. permit easier spindle installation and replacement,
g. can be repaired without special tools,
h. facilitate ready recognition of the product source, and
i. are formed in an aesthetically attractive and beneficially suggestive manner.

### SUMMARY OF THE INVENTION

These and other objects of the present invention are obtained by the provision of a torsion axle arrangement wherein the spindle is mounted to the suspension link by insertion into a split socket at one end of the suspension link, which is inclined with respect to the longitudinal axis of the suspension link. That connection is maintained by a bolt passing through the suspension link, engaging a mating groove or recess in the spindle, and then clamping the ends of the split socket together. The bolt is anchored to the suspension link by a threaded connection external to the suspension link. A chamfer or surface recess is formed in the surface of the suspension link for immediate source identification.

Other objects, advantages, and novel features of the present invention will become more readily apparent from the following drawings and detailed description of preferred embodiments of this invention.

### BRIEF DESCRIPTION OF THE DRAWINGS:

FIG. 1 shows a front view of a preferred embodiment of a removable spindle assembly, according to the present invention.

FIG. 2 shows top exploded view of the disassembled components of embodiment of FIG. 1.

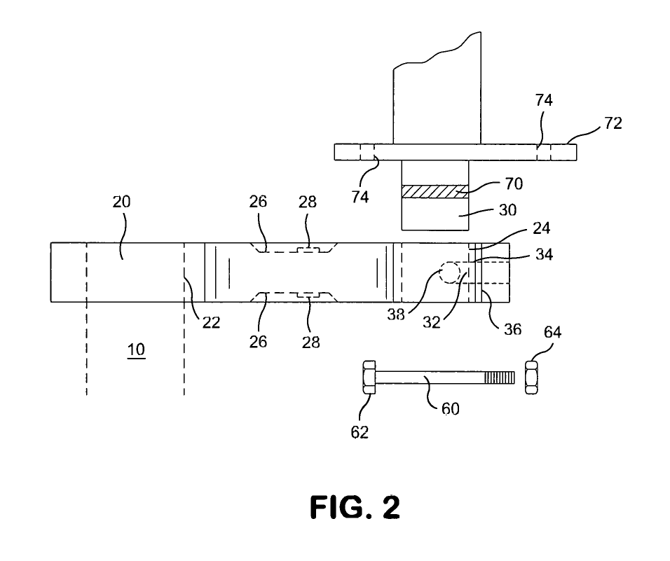

FIG. 3 shows a photographic front view of the aesthetic design of the present invention, corresponding to the embodiment of FIG. 1.

FIG. 4 shows a photographic view of the disassembled components of FIG. 3.

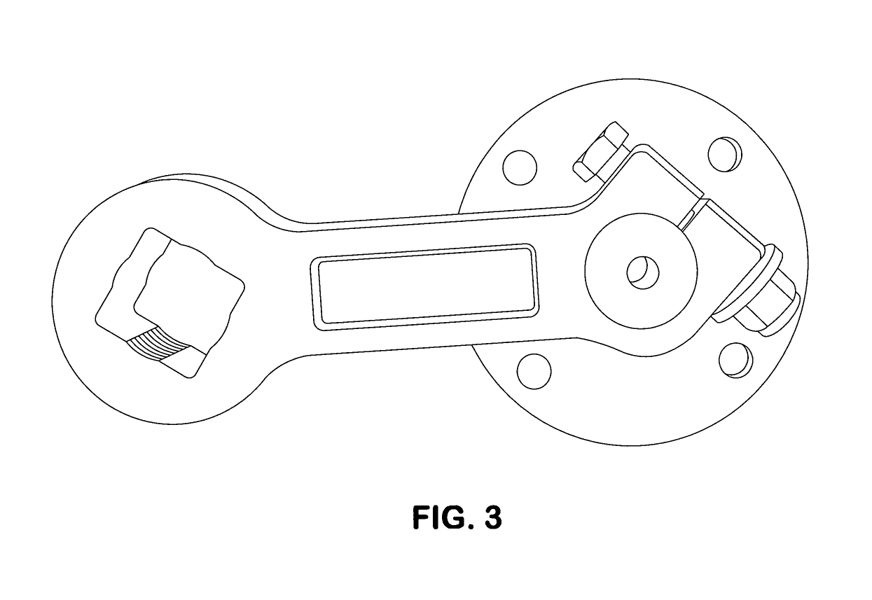

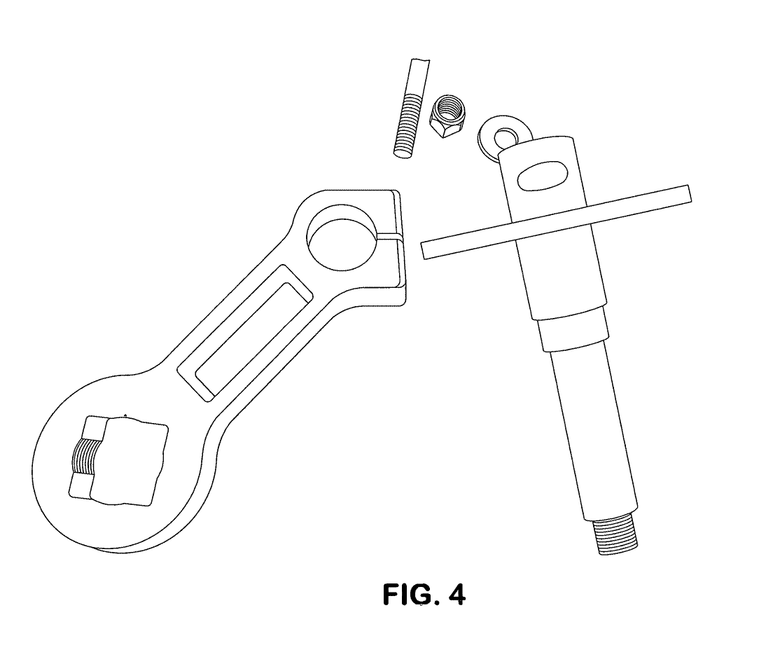

The background in FIGS. 3 and 4 form no portion of the claimed invention.

### DETAILED DESCRIPTION OF PREFERRED EMBODIMENTS

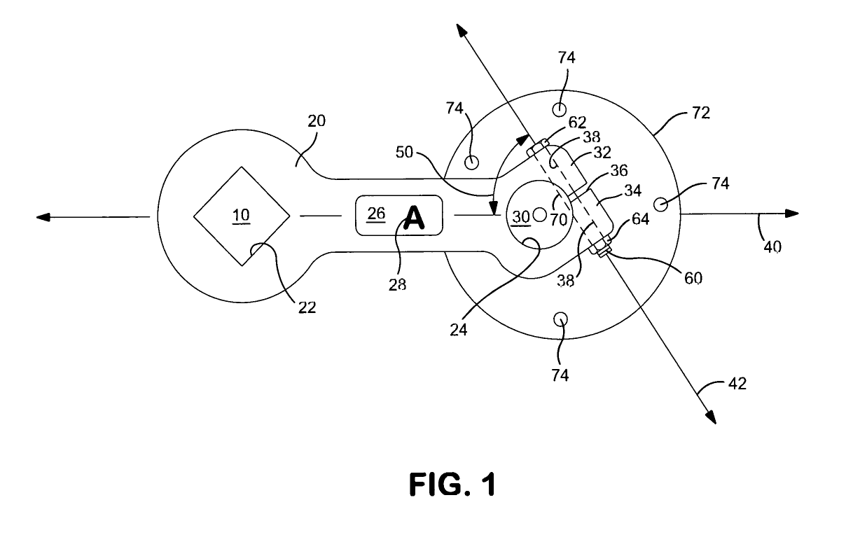

FIG. 1 shows a preferred embodiment of a torsion axle arrangement of the present invention, from a front view of the spindle and suspension link connection. This arrangement includes torsion axle element 10, suspension link 20, and spindle 30. In this view, torsion axle element 10 would be extending upward from the plane of the figure, spindle 30 would be extending downward from the plane of the figure, and suspension link 20 would be extending across the plane of the figure, substantially along longitudinal axis 40. Torsion axle element 10 may be of any desired configuration, including a variety of conventional constructions. Spindle 30 can be of any desired configuration, including conventional constructions, except as to include certain features for retention to the suspension link, as set forth herein.

Suspension link 20 includes an aperture 22 or other suitable device for connection to torsion axle element 10, generally positioned at one end thereof. Suspension link 20 also includes an aperture 24 for receiving a portion of spindle 30 (usually an end thereof), generally positioned at the other end thereof from aperture 22, along axis 40. Intermediate apertures 22 and 24, a chamfer portion 26 or recess is formed on the face of suspension link 20 on at least one side thereof. Within this recess an indicia 28 is located which provides a means for identifying the brand or source of the manufacturer of the suspension link and/or spindle. This indicia can be, for example, a raised or embossed mark of any desired configuration, which can be felt by touch and recognized by the user even when the recess is covered or partially filled by grease, dirt, or other grime. Alternatively, this indicia can be a label which is readily viewed when wiped to remove material obstructing its view. In especially preferred embodiments, chamfer portion 26 and indicia 28 are formed on both sides of suspension link 20.

Suspension link 20 also includes a split socket arrangement formed from arms 32 and 34, spaced apart by slot 36 leading from aperture 24. A passageway 38 extends through both arms 32 and 34, having a longitudinal axis 42. Axis 42 intersects axis 40 at an acute angle 50, such that passageway 38 is inclined with respect to the longitudinal axis of suspension link 20. Passageway 38 is formed such that a conventional bolt can pass through passageway 38, connecting arms 32 and 34, with shank 60 of the bolt located largely within passageway 38. The head 62 of the bolt would be outside of passageway 38 and adjacent either arm 32 or arm 34. A nut or washer/nut combination 64 is connected to the bolt opposite head 62, in a conventional manner, and is located adjacent the other or arm 32 or arm 34, with respect to head 62. Tightening nut 64 onto shank 60 of the bolt serves as a means to clamp or draw arms 32 and 34 together, constricting slot 36, and securing spindle 30 to suspension link 20. In certain embodiments, a threaded portion of arm 34 can be used to replace nut 64, but using nut 64 can permit easier maintenance of the assembly in instances where material would build up and interfere with the threading of the bolt tightening and releasing arms 32 and 34.

As mentioned above, spindle 30 can be of a conventional or other configuration, but in preferred embodiments of the present invention, spindle 30 includes a recess 70 therein which corresponds, at least in part, to a portion of passageway 38 and bolt shank 60. Recess 70 allows shank 62 to block removal of spindle 30 from aperture 24. Spindle 30 also typically includes a brake flange 72 with mounting holes 74 therein for receiving and retaining a brake assembly. Angle 50 of inclination of passageway 38, and the angle or configuration of recess 70 with respect to spindle 30, are preferably established so as to permit application of wrenches and other tools to bolt head 62 and nut 64 without interference from flange 72 and the brake fasteners used in holes 74. Angle 50 can also facilitate the reverse situation, where the application of tools to the brake fasteners used in holes 74 is not impeded (or is less impeded) by the suspension link or bolt head 62 and nut 64.

In especially preferred embodiments, passageway 38 is formed such that during normal use of the vehicle, head 62 of the bolt rests on a top or upper surface of suspension link 30 at arm 32, with bolt shank 60 extending vertically downward into arm 34. Thus, even if, somehow, nut 64 works itself loose and becomes unthreaded from the bolt, the effect of gravity on the bolt and the length of passageway 38 will tend to keep the bolt within passageway 38 and in engagement with enough of recess 70 that spindle 30 cannot be removed from aperture 24 and separated from suspension link 20.

With this arrangement, spindle 30 can be readily attached to and removed from suspension link 20 for initial assembly, as well as for service, repair, replacement, and/or maintenance, and yet be reliably connected during normal usage.

In addition, as shown in FIGS. 3 and 4, in preferred embodiments of the present invention, the configuration of suspension link 20 is formed to have an aesthetically pleasing shape, suggestive of strength, reliability and durability, as illustrated.

Although the present invention has been described and illustrated above with respect to particular embodiments, it will be readily understood that many variations of embodiments are contemplated by this invention which have not been enumerated herein. Accordingly, the spirit and scope of the present invention are limited only by the terms of the following claims which define the invention.

What is claimed is:

1. A torsion axle arrangement comprising:
a suspension link,
a spindle, and
means for removably connecting the spindle to the suspension link.

2. The torsion axle arrangement of claim 1 wherein:
the suspension link includes a split socket arrangement for receiving the spindle, and
a means for clamping the spindle within the split socket arrangement.

3. The torsion axle arrangement of claim 2 wherein:
the means for clamping includes a threaded bolt which passes through the split socket arrangement, and
the spindle includes a recess therein for receiving, at least in part, the bolt.

4. The torsion axle arrangement of claim 3 wherein the suspension link is formed along a longitudinal axis and the threaded bolt passes through the suspension link at an acute angle with respect to that longitudinal axis.

5. The torsion axle arrangement of claim 4 wherein the suspension link includes at least one recessed portion on its surface containing identifying indicia therein.

6. The torsion axle arrangement according to claim 5 having an aesthetic design substantially as shown and described in FIGS. 3 and 4.
